(19) United States
(12) Patent Application Publication
(10) Pub. No.: US 2023/0418063 A1
(43) Pub. Date: Dec. 28, 2023

(54) METHOD FOR ASCERTAINING A DIFFRACTION CHARACTERISTIC OF A HOLOGRAM ELEMENT FOR SMART GLASSES

(71) Applicant: Robert Bosch GmbH, Stuttgart (DE)

(72) Inventors: Simon Pick, Tuebingen (DE); Reinhold Fiess, Durbach (DE); Simone Hoeckh, Renningen (DE)

(21) Appl. No.: 18/249,916

(22) PCT Filed: Nov. 23, 2021
(86) PCT No.: PCT/EP2021/082577

§ 371 Date: Apr. 20, 2023

(30) Foreign Application Priority Data
Jan. 13, 2021 (DE) 10 2021 200 231.5

(51) Int. Cl. G02B 27/01; G02B 27/09; G02B 27/42; G03H 1/08

(52) U.S. Cl. CPC G02B 27/017; G02B 27/0944; G02B 27/4205; G03H 1/0808; G02B 2027/0174; G02B 2027/0178; G03H 2001/0825

(57) ABSTRACT

A method for ascertaining a diffraction characteristic of a hologram element for smart glasses. The method includes a step of outputting a light beam to an observation position on the hologram element by means of a light source, the light beam having at least one predefined wavelength and at least one sending parameter associated with the wavelength. The method also comprises a step of acquiring at least one reflection beam reflected at the observation position and/or transmission beam of the light beam having the predefined wavelength and transmitted through the hologram element at the observation position using at least one detector, wherein a detection parameter of the reflection beam and/or of the transmission beam is acquired at the predefined wavelength, and a step of comparing the sending parameter with the detection parameter in order to ascertain the diffraction characteristic of the hologram element at the observation position.

### FIELD

The present invention relates to a method for ascertaining a diffraction characteristic of a hologram element for smart glasses. The present invention also includes a control unit and a computer program.

### BACKGROUND INFORMATION

Hologram-based projection devices are used in a wide variety of applications, such as in the automotive industry or in connection with new types of display or sensor systems such as smart glasses.

### SUMMARY

The approach presented here in accordance with the present invention introduces an improved method for ascertaining a diffraction characteristic of a hologram element for smart glasses, a control unit which uses this method, and a corresponding computer program. Advantageous embodiments, developments, and improvements of the present invention are disclosed herein.

The present invention provides a way to achieve a characterization of a hologram element, for example for smart glasses, in terms of its angle- and wavelength-dependent diffraction efficiency which is direct, i.e., measured in reflection, with a manageable expenditure of time and money. According to an example embodiment of the present invention, a method for ascertaining a diffraction characteristic of a hologram element for smart glasses is provided, wherein the method comprises a step of outputting, a step of acquiring and a step of comparing. In the step of outputting, a light beam is output to an observation position on the hologram element using a light source, wherein the light beam comprises at least one predefined wavelength and at least one sending parameter associated with the wavelength. In the step of acquiring, at least one reflection beam reflected at the observation position and additionally or alternatively a transmission beam of the light beam having the predefined wavelength and transmitted through the hologram element at the observation position is acquired using at least one detector, wherein a detection parameter of the reflection beam and additionally or alternatively of the transmission beam is acquired at the predefined wavelength. In the step of comparing, the sending parameter is compared with the detection parameter in order to ascertain the diffraction characteristic of the hologram element at the observation position.

The hologram element can be integrated into a lens of the smart glasses or disposed on the lens, for example. The hologram element can also be configured a hologram layer, or comprise a plurality of hologram layers, for example, each of which is advantageous for a specific wavelength. The hologram element can moreover be implemented as a reflection hologram and additionally or alternatively as a transmission hologram. The method can advantageously be used in a flying spot system. The light beam can be output as white light, for example, for instance onto a specific region of the hologram element, so that the region is advantageously fully illuminated. The observation position can advantageously correspond to an eye position of a user of the smart glasses when they are in an operational state. The sending parameter of the light beam can advantageously represent an intensity of the light beam. The reflection beam and additionally or alternatively the transmission beam can advantageously be referred to as subbeams of the light beam. The detector can, for example, be formed as an analysis device configured to acquire the detection parameter. The detector can use the detection parameter to identify whether a portion of the intensity of the light beam was lost after reflection and additionally or alternatively after transmission, for example; i.e., whether the detection parameter deviates from the sending parameter. The method makes it possible to ascertain the diffraction characteristic of the hologram element, wherein, for all observation positions, the highest diffraction efficiency for beams coming from the direction of the light source and having the wavelengths used in the light source is advantageously located in the direction of the eye position of the user.

According to one example embodiment of the present invention, in the step of acquiring, an analysis detection parameter of the reflection beam and additionally or alternatively of the transmission beam can be acquired, which can be associated with a wavelength other than the predefined wavelength. In the step of comparing, the sending parameter can be compared with the analysis detection parameter in order to ascertain the diffraction characteristic of the hologram element at the observation position. The analysis detection parameter can represent a value that is acquired, for example, after a frequency shift of the hologram properties in relation to the hologram design specifications. This means, for example, that an examination point can deviate from an examination point associated with the detection parameter.

In the step of outputting, the sending parameter can represent an intensity value of the light beam. In the step of acquiring, a direction, intensity value and additionally or alternatively a wavelength of the reflection beam and additionally or alternatively of the transmission beam can be acquired as the detection parameter as well. The intensity value can advantageously additionally or alternatively represent a wavelength or a direction of the light beam. The detection parameter can include a current value, so that, for example, a loss of intensity in the hologram element can be inferred.

According to one example embodiment of the present invention, the steps of the method can be carried out repeatedly, in particular wherein, in the step of outputting, the light beam can be output to an observation position other than the observation position, and additionally or alternatively to the hologram element at a different angle. In the step of acquiring, the detection parameter can be acquired for another reflection beam reflected at the other observation position and additionally or alternatively for another transmission beam transmitted through the hologram element at the other observation position. The light beam can advantageously be output to a plurality of observation positions so that the diffraction characteristic can be measured for each of the observation positions within the region of the hologram element.

In the step of outputting, the light beam can also be output using a deflection element that can be tilted in at least two axes. In the step of outputting, the light beam can additionally or alternatively be output to the hologram element which has been rotated relative to the light source and additionally or alternatively the detector at least in at least one axis. In the step of acquiring, the other reflection beam and additionally or alternatively the other transmission beam can additionally or alternatively be acquired by the detector that has been moved relative to the hologram element. The deflection element can be configured as a mirror element, for example. The two axes can advantageously extend transversely to one another.

According to one example embodiment of the present invention, in the step of outputting, the light beam can be output using the deflection element, wherein at least one tilt axis of the deflection element extends through a position of an eye or a projector. Such an embodiment of the approach presented here provides the advantage of enabling a flexible and precise tilting or alignment of the deflection element.

In the step of outputting, a further light beam can moreover be output to the observation position, wherein the further light beam comprises at least one predefined further wavelength and at least one further sending parameter associated with the further wavelength. In the step of acquiring, at least one further reflection beam reflected at the observation position and additionally or alternatively a further transmission beam of the light beam having the predefined further wavelength transmitted through the hologram element at the observation position can be acquired using at least one detector, wherein a further detection parameter of the further reflection beam and additionally or alternatively of the further transmission beam can be acquired at the predefined further wavelength. In the step of comparing, the further sending parameter can be compared with the further detection parameter in order to ascertain the diffraction characteristic of the hologram element at the observation position. The further light beam can advantageously have a color that differs from a color of the light beam. The method can advantageously be carried out for the colors red, green, blue, so that a complete color spectrum can advantageously be covered.

According to one example embodiment of the present invention, in the step of outputting, the light beam can be output using a light source for outputting spectrally broadband light, in particular wherein the light source comprises at least a laser light source, an LED, a plasma light source and additionally or alternatively a thermal light source. The light source can advantageously be configured as a broadband light source that outputs white light. The light source can advantageously be configured as a multilaser or, for example, as an LED.

In the step of outputting, a reference beam having at least one reference parameter can furthermore be output using a beam splitter, wherein, in the step of comparing, the detection parameter can be compared with the reference parameter as the sending parameter in order to ascertain the diffraction characteristic of the hologram element at the observation position. The reference beam can advantageously have the intensity of the light beam.

The method according to the present invention can be implemented in software or hardware, for instance, or in a mixed form of software and hardware, for example in a control unit.

The present invention also provides a control unit that is configured to carry out, control or implement the steps of a variant of a method according to the present invention presented here in corresponding devices. This design variant of the present invention in the form of a control unit can likewise achieve the underlying object of the present invention quickly and efficiently.

For this purpose, according to an example embodiment of the present invention, the control unit can comprise at least one computing unit for processing signals or data, at least one memory unit for storing signals or data, at least one interface to a sensor or an actuator for reading in sensor signals from the sensor or for outputting control signals to the actuator, and/or at least one communication interface for reading in or outputting data embedded in a communication protocol. The computing unit can be a signal processor, a microcontroller or the like, for example, and the memory unit can be a flash memory, an EEPROM or a magnetic memory unit. The communication interface can be configured to read in or output data wirelessly and/or by wire, wherein a communication interface capable of reading in or outputting data transmitted by wire can read said data, for example electrically or optically, from a corresponding data transmission line or output the data to a corresponding data transmission line.

A control unit can be understood here to be an electrical device that processes sensor signals and outputs control signals and/or data signals as a function thereof. The control unit can comprise an interface that can be configured as hardware and/or software. When implemented as hardware, the interfaces can be part of a so-called system ASIC, for example, which contains various functions of the control unit. However, it is also possible that the interfaces are dedicated integrated circuits or consist at least partly of discrete components. When implemented as software, the interfaces can be software modules present, for example, on a microcontroller alongside other software modules.

A computer program product or a computer program comprising program code that can be stored on a machine-readable carrier or storage medium such as a semiconductor memory, a hard disk memory or an optical memory and can be used for carrying out, implementing and/or controlling the steps of the method according to one of the above-described embodiments of the present invention is advantageous as well, in particular when the program product or program is executed on a computer or a device.

Embodiment examples of the present invention are shown in the figures and explained in more detail in the following description.

### BRIEF DESCRIPTION OF EXAMPLE EMBODIMENTS

FIG. 1 a schematic illustration of smart glasses comprising a hologram element according to an embodiment example;

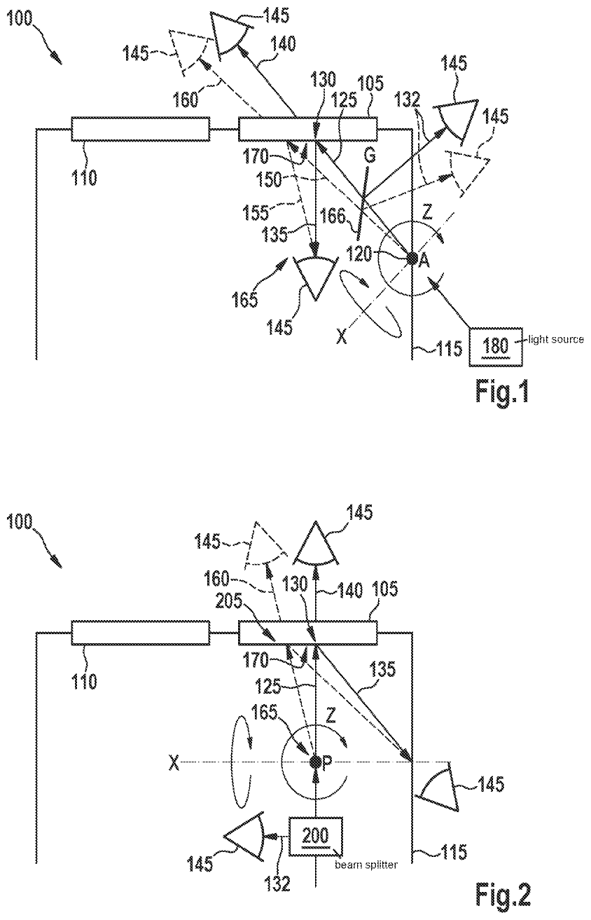

FIG. 2 a schematic illustration of smart glasses comprising a hologram element according to an embodiment example;

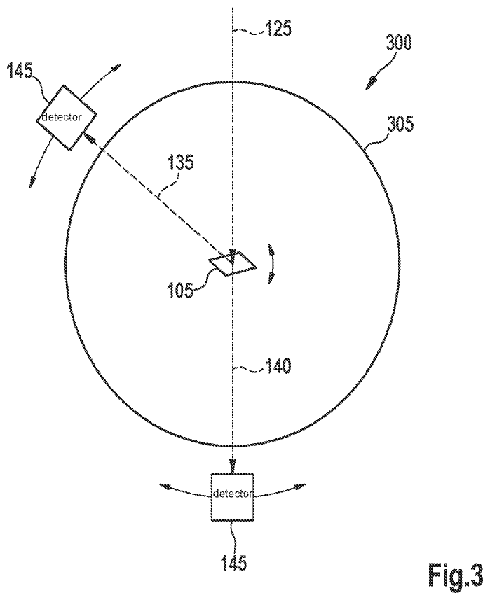

FIG. 3 a schematic illustration of a setup for carrying out a method according to an embodiment example for ascertaining a diffraction characteristic of a hologram element;

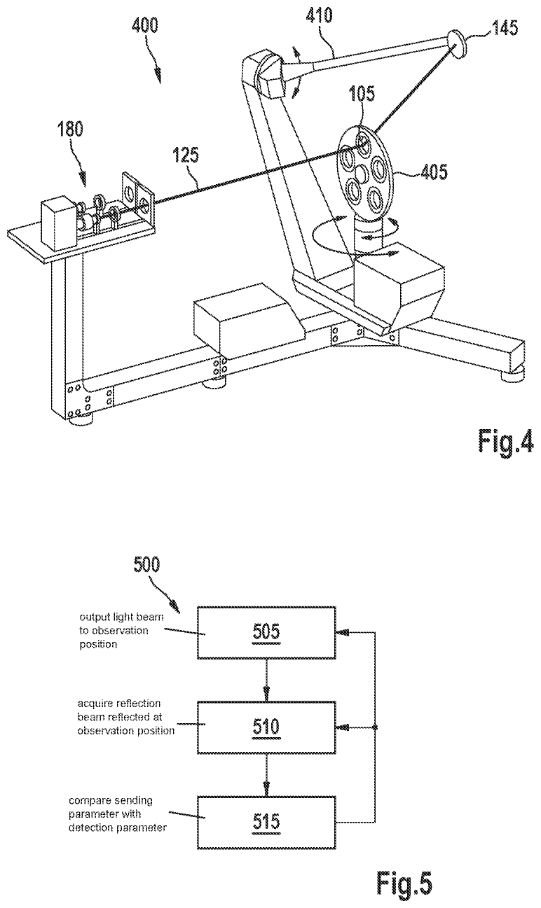

FIG. 4 a sketch of an apparatus for carrying out a method according to an embodiment example for ascertaining a diffraction characteristic of a hologram element;

FIG. 5 shows a flowchart of a method for ascertaining a diffraction characteristic of a hologram element according to an embodiment example of the present invention.

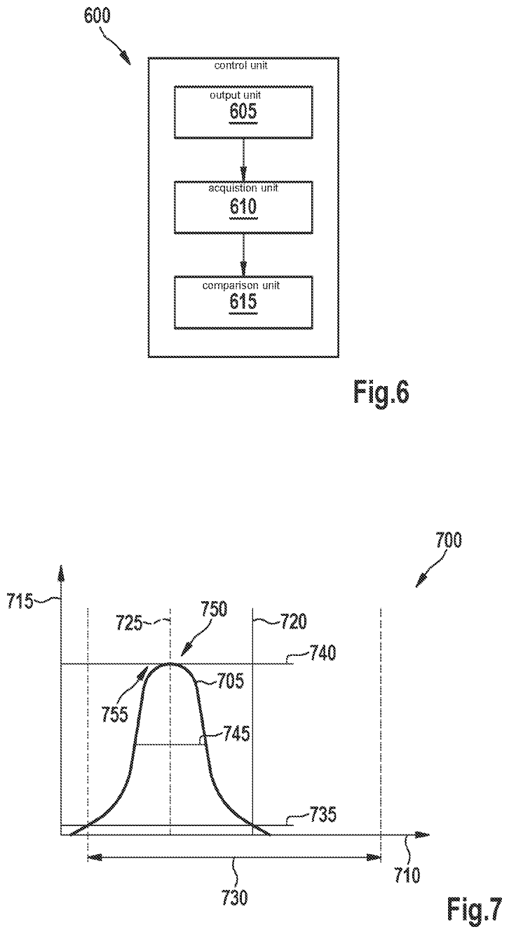

FIG. 6 shows a block diagram of a control unit according to an embodiment example of the present invention.

FIG. 7 shows a graph of an example result of a method according to an embodiment example of the present invention for ascertaining a diffraction characteristic of a hologram element.

### DETAILED DESCRIPTION OF EXAMPLE EMBODIMENTS

In the following description of favorable embodiment examples of the present invention, the same or similar reference signs are used for the elements which are shown in the various figures and have a similar effect, and a repeated description of these elements is omitted.

If an embodiment example comprises an “and/or” conjunction between a first feature and a second feature, this is to be read to mean that the embodiment example comprises both the first feature and the second feature according to one embodiment, and either only the first feature or only the second feature according to another embodiment.

FIG. 1 shows a schematic illustration of smart glasses 100 comprising a hologram element 105 according to an embodiment example. The hologram element 105 is configured as a lens. The hologram element 105 is configured as a layer, for example, for instance a hologram film, which is merely optionally disposed on the lens or, for example, integrated in the lens. It is optionally also possible that the hologram element 105 comprises a plurality of layers. A second lens 110 is configured as a simple disk, for example. Alternatively, it is possible that the second lens 110 be configured as a second hologram element.

According to this embodiment example, the smart glasses 100 comprise a light source 180 on a side piece 115 of the glasses, which is configured to output a light beam 125 to an observation position 130 on the hologram element 105. Alternatively, the light source 180 is disposed such that the light beam 125 hits a deflection unit A which can be moved about at least one axis X, Z, for example, from the outside. If disposed on the side piece 115, the light source 180 is merely optionally disposed such that it can rotate about the at least one axis X, Z and/or, for example, about a pivot point. According to this embodiment example, the smart glasses 100 further optionally comprise a tiltable deflection element G, which is disposed between the light source 180 and the hologram element 105, for example, and is configured to deflect the light beam 125 and/or a portion of the light beam 125 as the reference beam 132. The light beam 125 comprises at least one predefined wavelength and at least one sending parameter associated with the wavelength. The hologram element 105 is configured to reflect the light beam 125 at the observation position 130 as the reflection beam 135 and/or to transmit the light beam as the transmission beam 140. The reflection beam 135 and/or the transmission beam 140 have the wavelength of the light beam 125. According to this embodiment example, the reflection beam 135 and/or the transmission beam 140 are acquired by a detector 145. Stated more specifically, the detector 145 acquires a detection parameter of the reflection beam 135 and/or the transmission beam 140 at the predefined wavelength. The light source 180 merely optionally outputs a further light beam 150, which behaves similarly to the light beam 125. This means that, according to this embodiment example, the further light beam 150 is likewise reflected at the hologram element 105 as a further reflection beam 155 and/or transmitted through the hologram element 105 as a further transmission beam 160. Here, too, the detector 145 is configured to acquire the further reflection beam 155 and/or the further transmission beam 160. The light source 180 alternatively outputs the light beam 120 repeatedly, but to a different observation position 170, which, for example, is a point adjacent to the observation position 130 that is illuminated by the light beam 125 during the repeated output. The other reflection beam and/or other transmission beam that hits the other observation position 170 corresponds to the respective reflection beam 135 and/or transmission beam 140, so that these are not depicted separately according to this embodiment example for the sake of clarity. According to this embodiment example, a position of the detector 145, which is referred to as the eye position 165, for example, for acquiring the further reflection beam 155 coincides with the position of the detector 145 for acquiring the reflection beam 135, while the detector 145 for acquiring the further transmission beam 160 is positioned offset to the position when acquiring the transmission beam 140. According to this embodiment example, the detector 145 is therefore disposed such that it can move. Alternatively, a plurality of detectors 145 are or can be disposed at different positions around the hologram element 105, so that a plurality of beam paths are acquired at the same time, for example.

Recording methods for volume holograms are typically based on, for instance, bringing coherent shaped wave fronts, for example generated with laser beams, with a suitable opening cone and angle to one another into interference. Transmissive and/or reflective red-green-blue-holograms (RGB) are thus, for example simultaneously or sequentially, exposed to a photosensitive layer, such as photopolymers. Display systems are implemented as an RSD (retinal scan display, retina scanning display), for instance. This involves moving a suitably modulated light beam, for example line by line, across the retina of an observer at such a speed that the observer perceives a stationary image. Such systems are characterized, among other things, by the fact that the image does not have to already exist at an earlier point in the optical path. This makes it possible to limit the size of a system because, for example, there is no need for imaging lenses that capture a complete image. Systems that operate with a light beam scanned in this manner are also referred to as flying spot systems. The light beam can, for instance, be deflected via small moving mirrors, so-called micromirrors, having a diameter of approximately 1 to 3 mm, for example. Possible design variants are a mirror that oscillates in two orthogonal axes, for example, or two mirrors that respectively oscillate in one axis, wherein said two axes are aligned orthogonally to one another. One 2D or two 1D mirrors are used for this purpose, for example.

With this in mind, the light beam 125 is directed into the eye of the user at a hologram element 105, which can also be referred to as a reflection hologram (RHOE), that in the operational state according to this embodiment example is disposed at the eye position 165. There is a fixed angle and wavelength relationship for each wavelength, such as red, green, blue, and/or infrared (IR), present in the system. In a target configuration, the geometry of the system and the wavelength or wavelengths of the used light beam 125 are precisely matched to the hologram element 105 being used. The hologram element 105 that satisfies these conditions is a specifically designed, potentially very complex optical element, for instance, that requires nontrivial simulation and an equally sophisticated manufacturing process. In a development process, the function of such a hologram element 105 is therefore ideally measured comprehensively in terms of spectrum and geometry in order to identify the location of the maximum diffraction efficiency for each angle-wavelength combination at different positions of the light spot on the hologram element 105 and compare it with that desired for a specific laser diode selection.

Interesting is also the amount of maximum diffraction efficiency per wavelength to ensure eye safety, image brightness and/or image homogeneity, as well as a range of variation in wavelength and angle around this maximum, in which an image is still created in the eye. Simulation, design and manufacturing process are iteratively improved on the basis of this data. This is in particular also necessary for a practical application of embedding the hologram element 105 in curved, prescription corrected lenses. Because, for this purpose, the exposed hologram element 105 is subjected to manufacturing processes that change the optical function, such as curving the hologram film or embedding it in lenses under thermal and mechanical stress. The embedding material, too, changes an optical function of the hologram element 105, among other things, by refraction of the light on a cover material and polarization-dependent reflection of a portion of the light on the eye-side and world-side optical surface of the lens.

According to this embodiment example, a broadband light source 180 is used, for example, a white light source, the spectrum of which simultaneously includes all of the wavelengths occurring in the target system, and also a wavelength-sensitive detector 145, such as a spectrometer. The sequential use of individual discrete wavelengths and/or wavelength ranges is possible too, so that a non-wavelength-sensitive detector 145 can be used. The system is set, for instance, geometrically to its target configuration. This means that the position and direction of the light source 180 during a measurement, i.e. in the course of the method, corresponds to the beam path of the optical design, for example in that the position of the deflection unit A relative to the hologram element 105 is fixed. The light of a laser, the wavelength of which can be tuned, is guided over this deflection unit A. Ideally, light of exactly and only the desired wavelength ranges is deflected such that the maximum diffraction efficiency occurs at the desired location, the eye position 165. The approach presented here allows the maxima of the diffraction efficiency to be ascertained as a function of the wavelength. The restriction of the angles to those of the target configuration underlying this approach is carried out with the intent to simplify and accelerate the method.

The direct measurement of the deflected light, which is referred to here as the reflection beam 135, 155 and/or as the transmission beam 140, 160, is furthermore carried out without or with significantly reduced tracking. Since the approach works largely with the components and in the geometry of the target system, it is ensured that what is being examined is exactly what is also relevant in the final system. Effort and costs are reduced as well. Improvement takes place over time, because the sample does not have to be rotated into many different angular positions as is customary for transmission measurements and then fully examined in each one. Since a direct angle and wavelength relationship is given for volume holograms via the fulfillment of the Bragg condition, which describes an interference of two coherent waves in sufficiently thick holographic material, the angles and/or angular ranges and the wavelengths and/or wavelength ranges at which the diffraction efficiency is maximum can be converted into one another. In an alternative implementation of the approach, the reverse approach described in one of the following figures, the light beam 125 likewise follows the design beam path, but in the opposite direction, wherein the light spot always falls from a point, also referred to as a pivot point, near the eye position 165 onto a subregion of the hologram element 105. In this case, the light beam 125 sequentially scans all relevant regions of the hologram element 105 by rotating about the pivot point about two axes which are approximately perpendicular to one another and to a hologram element normal. The reverse approach merely optionally exploits the fact that, regardless of the details of the optical design of the flying spot system, the pupil is always hit with collimated light from the known angular range of the field of view. The origin of this light from the light source 180 is also known with geometric precision and is tightly circumscribed by the exit opening of the projector, which enables the detector 145 to be fixedly positioned relative to the hologram element 105 at the location of the exit opening. The reverse approach thus also allows the simple characterization of the lens without the presence of a flying spot projector, for example if these are not available (yet) or do not have sufficient quality. This is in particular relevant if the projector comprises complex, difficult to manufacture elements, such as a free-form lens, between the scanning mirrors and the hologram element 105.

In the forward approach, according to this embodiment example, the light beam 125 falls on the deflection unit A, which is configured as a micromirror, for example. The deflection unit A moves such that the light beam 125 is scanned across the hologram element 105. The use of the deflection unit A in the measurement setup is an elementary advantage of the here-described approach. By using it, the angles of incidence of the light beam 125 onto the hologram element 105 during the measurement of the hologram element 105 are realized with positional accuracy, just as they occur during operation of the target system. This is possible even in complicated designs with curved corrective lenses, monoaxial MEMS mirrors which are offset and rotated relative to one another, free-form lenses, and other elements in the beam path that lead to extremely complicated distributions of the angles of incidence and the angles of emergence on the hologram element 105.

In another embodiment, an additional element is used that can quickly switch the light beam 125 on and off. In a flying spot system, the light source 180 is amplitude modulated in synchronization with the movement of the mirror, for example in order to be able to write individual pixels and thus an image. On the other hand, if a tunable laser is used as the light source 180 in the here-proposed measurement setup, it is expected that said laser cannot simply be modulated in synchronization with the deflection unit A in the same way as the laser diodes in place of which it is used, and in particular cannot be switched on and off quickly enough. In order to nonetheless be able to write and measure images, in particular test images such as small rectangles, edges, lattices, etc., a further element, such as an acousto-optic modulator (AOM), can merely optionally be used. This is placed in the optical path in front of the deflection unit A, for example. Since the AOM can be used here as a quick switch, a zeroth order beam is the useful beam. A wavelength-dependent deflection or a frequency shift, as experienced by the higher order beam, is not used here.

According to a further embodiment example, instead of the laser, another, broader-band light source 180, such as a thermal light source, is used, which has sufficiently low divergence with sufficient brightness for practicable measurement times and signal-to-noise ratio. The light deflected by the hologram element 105, which is referred to here as the reflection beam 135, 155, is acquired by a detector 145 which can be referred to as a sensor. The detector 145 is, for example, placed such that the reflection beam 135, 155 hits it at the eye position 165. A sensor surface and/or an entry opening of a housing is deliberately selected to be large, on the one hand, to capture as much of the deflected light 135, 155 as possible and, on the other hand, to be able to do so even if an emergence direction changes due to the change in wavelength. In another embodiment example, this involves a spatial resolution of the examined area on the hologram element 105. For this purpose, the light source 180 is merely optionally switched in synchronization with the position of the deflecting element. For instance, only a small measuring spot, which corresponds to one pixel of the video signal, for example, can be illuminated and characterized on the hologram element 105 at a given time, wherein said measuring spot is then moved sequentially over the entire hologram element 105. Local changes in the properties of the hologram element 105, such as can be expected, for instance, when a hologram element film is precurved and/or embedded in a lens, for example by mechanical deformation and shrinkage of the film, can thus be detected as well.

According to one embodiment example, this involves a spatial resolution of the detected light. For this purpose, either the position-dependent distribution of the detected light on the sensor surface can be used, or the detector 145 can be moved, which is carried out manually or advantageously automatically in an adaptive manner. Angle information can thus be obtained as well, at least in a certain spatial range. The wavelength considered at a given time is selected via the tunable light source 180. The detector 145 therefore does not necessarily have to be able to analyze the wavelength of light hitting it. Nonetheless, for reasons of accuracy and redundancy, a spectrometer can be used as the detector 145. A portion of the useful light is further optionally split off, at a location G, for example with a beam splitter or a small glass plate, and directed to a further detector 145. If this splitting occurs in the optical path after the deflection unit A, the scanning nature of the system has to be taken into account. If the splitting occurs in front of the deflection unit A, it has to be ensured that no light is lost at the deflection unit A, i.e. it does not represent the smallest aperture. Alternatively or additionally, the portion of the light that is not deflected at the hologram element 105, i.e. transmitted, that is the transmission beam 140, 160, is likewise captured by a suitable detector 145. For practical reasons and in view of comparability, in another embodiment example, all of the detectors 145 used are, for example, the same model. Since the beam is scanned, the analysis of the transmitted light 140, 160 and possibly also of the light split off via a beam splitter after the deflection unit A is most easily possible for a specific angle of incidence and thus for a specific position on the deflection unit A, for example that of a standing beam. Thus a reference point is created. These detectors 145 are moreover optionally configured to be movable, so that different hologram angles of emergence and thus positions on the deflection unit A can be analyzed accordingly. Very large detector surfaces 145 positioned very close to the lens are alternatively possible as well, so that the light beams 140, 160, 132 are acquired on the deflection element 166 for every angle of incidence. By suitably calibrating the detectors 145 and evaluating the data from the detectors 145, the energy or the power of the light incident on the hologram element 105, possibly the transmission beams 140, 160 and the reflection beams 135, 155, for example, can be taken into account and respectively set in relation to one another. Supplemented by corresponding blank and reference measurements, the maximum of the diffraction efficiency in the examined region can be ascertained from this as a function of the wavelength and possibly also as a function of the angle. It is also ascertained how large a proportion of the light is that is neither deflected into the eye nor transmitted directly, for example due to Fresnel reflection or absorption.

According to an alternative embodiment example, an additional element, for example a depolarizer, λ/2 plate and alternatively or additionally a λ/4 plate depending on the polarization stability of the light source used and alternatively or additionally also a polarizing filter, is introduced into the beam path in front of and/or after the deflection unit A to set the polarization of the laser light. Such a setting option is advantageous, because both the unit of the deflection unit A and the layers located on and around the sample carrying the hologram element 105, and the detector 145 itself, exhibit polarization-dependent effects. Depolarizers, polarizing filters and A plates, for example, are alternatively or additionally also used in front of the detectors. By using a detector 145 that analyses the transmitted light 140, 160, the approach presented here merely as an example also allows pure transmission measurements at variable wavelength.

In other words, according to this embodiment example, FIG. 1 shows the forward approach using the smart glasses 100. The beam path indicated with a solid line according to this embodiment example is realized, for example, at a different time and thus in a different position of the deflection unit A than the beam path indicated with a dashed line.

FIG. 2 shows a schematic illustration of smart glasses 100 with a hologram element 105 according to an embodiment example in the reverse approach. A setup for a method for ascertaining the diffraction characteristic of the hologram element 105 for the smart glasses 100 according to this embodiment example is shown, for example as will be explained in more detail in one of the following figures. The reverse beam path shown here is also referred to, for instance, as the reverse approach. According to this embodiment example, the light beam 125 is deflected at a pupil point P, for instance by a deflection unit, when the light beam 125 is output repeatedly, for example. Furthermore, according to this embodiment example, a beam splitter 200 is disposed in front of the pupil point P, for example to illuminate an observation region 205 of the hologram element 105 and at the same time obtain the reference beam 132. The observation region 205 comprises the observation position 130, for example, as well as a different observation position 170 located adjacent the observation position 130, for example. The smart glasses 100 shown here corresponds to or at least resembles the smart glasses 100 described in FIG. 1. The only difference according to this embodiment example is a direction of the light beam 125 and/or the further light beam 150. This means that, according to this embodiment example, the light beam 125 passes a pupil point P, which corresponds to the eye position 165 of the user, is reflected at the hologram element 105 as a reflection beam 135 and is ultimately acquired by the detector 145 on the side piece 115. According to this embodiment example, the light beam 125 can be rotated in two axes X, Z at the pupil point P, so that it covers the entire observation region 205, for example. Alternatively, as in FIG. 1, the light beam 125 is transmitted through the hologram element 105 as a transmission beam 140.

In other words, the reverse approach is shown according to this embodiment example. The beam path indicated with a solid line is realized at a different time and thus in a different position, for example of the deflection unit, than the beam path indicated with a dashed line.

In the “reverse approach” shown according to this embodiment example, the light is passed through the eye position 165, more specifically the pupil, onto the hologram element 105. The collimated light spot here thus follows “visual beams” from a vanishing point pupil over the defined angular range of the field of view. At least one detector 145 is positioned at a location of the flying spot projector in the product such that it is stationary relative to the hologram element 105. Here, too, the light source is used, for example with a wavelength that is detuned with respect to the target wavelength. The same applies to the abovementioned further detectors 145, with which a reference beam 132 is split off in front of the hologram element 105 and/or the portion 140, 160 transmitted through the hologram element 105 is measured. The detectors 145 are again, for example, movable. Polarization-influencing elements are further optionally used as well. Angular scanning of the hologram element 105 is implemented in different ways, for example by rotating the incident light spot direction relative to hologram element 105. For example, when the light source is stationary, the transmission detector 145 is stationary and the light spot direction is fixed, the hologram element 105 and the detector 145 that acquires the reflection beam 135, 155 are rotated together about the described two axes through the design position of the pupil, for example by means of motorized goniometers. Alternatively, when the light source is stationary, the light spot is deflected at the location of the pupil, for example by a deflection element, such as a 2-axis tilt mirror, while the detector 145 for the transmission beams 140, 160 is moving and the detector 145 for the reflection beams 135, 155 is stationary.

FIG. 3 shows a schematic illustration of a setup 300 for carrying out a method according to an embodiment example for ascertaining a diffraction characteristic of a hologram element 105. The figure shows a beam path of the light beam 125 according to this embodiment example. As also described in FIGS. 1 to 2, the light beam 125 is reflected at the hologram element 105 as a reflection beam 135 which is acquired by the detector 145. Additionally, or alternatively, the light beam 125 is transmitted through the hologram element 105 as a transmission beam 140. According to this embodiment example, the at least one detector 145 and the light beam 125 are configured such that they can move in at least one direction relative to the hologram element 105. The setup 300 depicted here makes it possible to measure an angle-dependent behavior of the hologram element 105.

In other words, the figure shows the setup 300 in which the hologram element 105 is disposed, for example, on a turntable 305. The hologram element 105 is hit at a specific point in time by monochromatic light, for instance from a spectrometer. The detector 145 can be moved about the same vertical axis.

FIG. 4 shows a sketch of an apparatus 400 for carrying out a method according to an embodiment example for ascertaining a diffraction characteristic of a hologram element. The hologram element 105, which according to this embodiment example can be inserted into the apparatus 400 as a sample, corresponds to the hologram element 105 described in one of FIGS. 1 to 3, for example. The method for characterizing the hologram element 105 described in one of the following figures can, for example, be carried out using the apparatus 400 shown here. The apparatus 400 comprises the light source 180 and at least one detector 145. According to this embodiment example, the apparatus 400 also comprises a sample holder 405 configured to accommodate and/or hold at least one sample, i.e. at least one hologram element 105. According to this embodiment example, the detector 145 is disposed on a detector arm 410, which is configured such that it can move, for example. According to this embodiment example, the sample holder 405 is movable as well, in particular configured such that it can be rotated in two opposite directions. According to this embodiment example, the possible movements of the apparatus 400 can be carried out simultaneously.

FIG. 5 shows a flowchart of a method 500 for ascertaining a diffraction characteristic of a hologram element according to an embodiment example. The method 500 is used to ascertain the diffraction characteristic of a hologram element, for example as described in one of FIGS. 1 to 3. The method 500 can be carried out in an apparatus, for example, or using a setup as described in at least one of FIGS. 3 to 4. According to this embodiment example the method 500 comprises a step 505 of outputting, a step 510 of acquiring and a step 515 of comparing. In the step 505 of outputting, a light beam is output to an observation position on the hologram element using a light source, wherein the light beam comprises at least one predefined wavelength and at least one sending parameter associated with the wavelength. In the step 510 of acquiring, at least one reflection beam reflected at the observation position and additionally or alternatively a transmission beam of the light beam having the predefined wavelength and transmitted through the hologram element at the observation position is acquired using at least one detector, wherein a detection parameter of the reflection beam and additionally or alternatively of the transmission beam is acquired at the predefined wavelength. In the step 515 of comparing, the sending parameter is compared with the detection parameter in order to ascertain the diffraction characteristic of the hologram element at the observation position.

In the step 505 of outputting, the sending parameter merely optionally represents an intensity value of the light beam. Therefore, in the step 510 of acquiring, an intensity value of the reflection beam and/or the transmission beam is acquired as the detection parameter. In the step 505 of outputting, the light beam is further optionally output using a light source for outputting white light. The light source comprises at least a laser light source, an LED, and/or a thermal light source, for example. According to this embodiment example, in the step 505 of outputting, a reference beam having at least one reference parameter is output using a beam splitter. Therefore, in the step 515 of comparing, the detection parameter is compared with the reference parameter as the sending parameter in order to ascertain the diffraction characteristic of the hologram element at the observation position.

In the step 510 of acquiring, an analysis detection parameter of the reflection beam and/or the transmission beam which is associated with a wavelength other than the predefined wavelength is merely optionally acquired. The analysis detection parameter is to be understood as a current value, for instance, that is based on a frequency shift and can therefore be described as an examination point that deviates from an expected value. According to this embodiment example, in the step 515 of comparing, the sending parameter is compared with the analysis detection parameter in order to ascertain the diffraction characteristic of the hologram element at the observation position.

According to this embodiment example, the steps 505, 510, 515 of the method 500 are carried out repeatedly. In the step 505 of outputting, the light beam is in particular output to an observation position other than the observation position and/or at a different angle to the hologram element. In this case, in the step 510 of acquiring, the detection parameter is acquired for another reflection beam reflected at the other observation position and/or for another transmission beam transmitted through the hologram element at the other observation position. This means that the other observation position is, for instance, a point adjacent the observation position that is illuminated by the light beam when the method is repeated. The other reflection beam and/or the other transmission beam corresponds to the respective reflection beam and/or the transmission beam. In the step 505 of outputting or when outputting is repeated, the light beam is further optionally output using a deflection element that can be tilted in at least two axes and/or to the hologram element. For this purpose, the hologram element was rotated in at least one axis with respect to the light source and/or the detector. In the step of acquiring, the other reflection beam and/or the other transmission beam is additionally or alternatively acquired by the detector that has been moved relative to the hologram element. In other words, according to this embodiment example, the same light beam is output to the other observation position and the method is repeated for each and every observation position of the hologram region. In the step 505 of outputting, a further light beam, which comprises at least one predefined further wavelength and at least one further sending parameter associated with the further wavelength, is additionally or alternatively output to the observation position. Consequently, in the step 510 of acquiring, at least one further reflection beam reflected at the observation position and/or a further transmission beam of the light beam having the predefined further wavelength transmitted through the hologram element at the observation position is acquired using the at least one detector. A further detection parameter of the further reflection beam and/or the further transmission beam is further optionally acquired at the predefined further wavelength, before the further sending parameter is compared with the further detection parameter in the step 515 of comparing in order to ascertain the diffraction characteristic of the hologram element at the observation position. This means that the color of the light beam according to this embodiment example differs from the color of the further light beam, as is the case with an RGB light source, for example, in order to cover a complete color spectrum.

FIG. 6 shows a block diagram of a control unit 600 according to an embodiment example. The control unit 600 is, for example, configured to carry out or at least control a method for ascertaining a diffraction characteristic of a hologram element for smart glasses as described in FIG. 5 for instance. The control unit 600 can, for example, be connected and/or is connected to an apparatus for carrying out the method as described in FIG. 4 for instance.

For this purpose, the control unit 600 comprises an output unit 605, which is configured to cause a light beam to be output to an observation position on the hologram element using a light source, wherein the light beam comprises at least one predefined wavelength and at least one sending parameter associated with the wavelength. The control unit 600 further comprises an acquisition unit 610, which is configured to cause at least one reflection beam reflected at the observation position and/or transmission beam of the light beam having the predefined wavelength and transmitted through the hologram element to be acquired at the observation position using at least one detector, wherein a detection parameter of the reflection beam and/or of the transmission beam is acquired at the predefined wavelength. The control unit 600 also comprises a comparison unit 615, which is configured to cause the sending parameter to be compared with the detection parameter in order to ascertain the diffraction characteristic of the hologram element at the observation position.

FIG. 7 shows a graph of an example result of a method according to an embodiment example for ascertaining a diffraction characteristic of a hologram element. The example result presented here shows a comparative example for a method for ascertaining a diffraction characteristic of a hologram element for smart glasses as described in FIG. 5 for instance.

The graph 700 shows a bell-shaped curve 705, which illustrates a diffraction efficiency for a wavelength of an acquired reflection beam and/or an acquired transmission beam. An x-axis 710 of the graph represents the wavelength A and a y-axis 715 of the graph represents the intensity of the received light at the corresponding wavelength A. According to this embodiment example, a hologram element should be configured such that light of the wavelength 720, for instance, is reflected as well as possible. According to this embodiment example, light having the wavelength 720 has an emitted intensity that represents a sending parameter 735, for example. If it is now recognized that an intensity distribution 705 corresponding to the bell-shaped curve from the illustration according to FIG. 7 is obtained at the detector for a received light at different wavelengths A, this information can be used to infer the reflection properties or the diffraction characteristic of the hologram element. The obtained bell-shaped curve of the intensity distribution depicted here, which has a maximum 740 at a wavelength 725 and is smaller than the wavelength 720 and, when the hologram element has the desired diffraction characteristic or the corresponding reflection properties, corresponds to the emitted light or the expected intensity maximum of the reflected light, now makes it possible to identify this deviation and thus classify or evaluate the hologram element accordingly. The spectral position 750, width 745 and height 740 of the intensity maximum of the wavelength 725 can then also be understood as detection parameters 750, because these parameters can be used to very precisely map the diffraction characteristic or the reflection properties. To identify such a deviation of the intensity maximum position 755 of the radiation received at the detector, the light can, for instance, be varied in a wavelength range 730, for example by using a tunable laser, so that an intensity maximum can be identified at the wavelength 725 of the light reflected by the hologram element.

In other words, an example of a measurement result of a flying spot system is shown. The flying spot system works with laser diodes, for instance, that emit light of the required wavelengths, for example RGB. A monochromatic system with only one laser diode is possible too. The hologram element to be characterized is deliberately examined with light that is shifted in its wavelength λ, which comprises the detection parameter 725, for example, to the target wavelength 720 or the design wavelength. A diffraction maximum is thus found as a function of the wavelength 720 and the height 740 and width 745 of the wavelength band at which the hologram element acts is determined, which is shown using the curve 705, for example. If only the wavelength-angle combination targeted for the finished system is used, effects occur, such as the shifted position of the diffraction maximum shown here, that typically occur as a result of shrinking effects during the production and further processing of the hologram element, for example, and are not found and in particular not analyzed in more detail. Such an analysis should, however, be possible in a quality control process and in particular in a development process with all of its typically iterative steps. Such effects are to be avoided or are already taken into account or precompensated in design in order to enable a reproducible manufacturing process. A tunable laser is used as the light source, for example. The tunable range includes all wavelengths at which the hologram element is examined. The use of laser light enables a beam profile that in particular allows the beam to be guided with low loss over the deflection element, which typically represents a small aperture, to ensure a good signal-to-noise ratio of the measurement due to high intensity, enable high spatial resolution on the hologram due to good focusability and generally be so similar to the laser light used in the target system, that it is influenced by the hologram element in as similar a manner as possible.

1-12. (canceled)

13. A method for ascertaining a diffraction characteristic of a hologram element for smart glasses, the method comprising the following steps:
outputting a light beam to an observation position on the hologram element using a light source, wherein the light beam includes at least one predefined wavelength and at least one sending parameter associated with the wavelength;
acquiring at least one reflection beam diffracted at the observation position and/or transmission beam of the light beam having the predefined wavelength and transmitted through the hologram element at the observation position using at least one detector, wherein a detection parameter of the reflection beam and/or of the transmission beam is acquired at the predefined wavelength; and
comparing the sending parameter with the detection parameter to ascertain the diffraction characteristic of the hologram element at the observation position.

14. The method according to claim 13, wherein, in the acquiring step, an analysis detection parameter of the reflection beam and/or the transmission beam associated with a wavelength other than the predefined wavelength is acquired, wherein, in the comparing step, the sending parameter is compared with the analysis detection parameter to ascertain the diffraction characteristic of the hologram element at the observation position.

15. The method according to claim 13, wherein, in the outputting step, the sending parameter represents an intensity value of the light beam, and wherein, in the acquiring step, a direction and/or intensity value and/or a wavelength of the reflection beam and/or the transmission beam is acquired as the detection parameter.

16. The method according to claim 13, wherein the steps of the method are carried out repeatedly, wherein, in the outputting step, the light beam is output to a different observation position and/or to the hologram element at a different angle, wherein, in the acquiring step, the detection parameter is acquired for another reflection beam reflected at the different observation position and/or for another transmission beam transmitted through the hologram element at the different observation position.

17. The method according to claim 16, wherein: (i) in the outputting step, the light beam is output using a deflection element that can be tilted in at least two axes, and/or (ii) in the outputting step, the light beam is output to the hologram element which has been rotated relative to the light source and/or the detector at least in at least one axis and/or (iii) in the acquiring step, the other reflection beam and/or the other transmission beam is acquired by the detector that has been moved relative to the hologram element.

18. The method according to claim 17, wherein, in the outputting step, the light beam is output using the deflection element, wherein at least one tilt axis of the deflection element extends through a position of an eye or a projector.

19. The method according to claim 13, wherein, in the outputting step, a further light beam is output to the observation position, wherein the further light beam includes at least one predefined further wavelength and at least one further sending parameter associated with the further wavelength, wherein, in the acquiring step, at least one further reflection beam reflected at the observation position and/or a further transmission beam of the light beam having the predefined further wavelength transmitted through the hologram element at the observation position is acquired using at least one detector, wherein a further detection parameter of the further reflection beam and/or the further transmission beam is acquired at the predefined further wavelength, and wherein, in the comparing step, the further sending parameter is compared with the further detection parameter to ascertain the diffraction characteristic of the hologram element at the observation position.

20. The method according to claim 13, wherein, in the outputting step, the light beam is output using a light source configured to output spectrally broadband light, the light source including at least a laser light source and/or an LED and/or a plasma light source and/or a thermal light source.

21. The method according to claim 13, wherein in the outputting step, a reference beam having at least one reference parameter is output using a beam splitter, wherein, in the comparing step, the detection parameter is compared with the reference parameter as the sending parameter to ascertain the diffraction characteristic of the hologram element at the observation position.

22. A control unit configured to ascertain a diffraction characteristic of a hologram element for smart glasses, the control unit configured to:
output a light beam to an observation position on the hologram element using a light source, wherein the light beam includes at least one predefined wavelength and at least one sending parameter associated with the wavelength;
acquire at least one reflection beam diffracted at the observation position and/or transmission beam of the light beam having the predefined wavelength and transmitted through the hologram element at the observation position using at least one detector, wherein a detection parameter of the reflection beam and/or of the transmission beam is acquired at the predefined wavelength; and
compare the sending parameter with the detection parameter to ascertain the diffraction characteristic of the hologram element at the observation position.

23. A non-transitory machine-readable storage medium on which is stored a computer program ascertaining a diffraction characteristic of a hologram element for smart glasses, the computer program, when executed by a computer, causing the computer to perform the following steps:
outputting a light beam to an observation position on the hologram element using a light source, wherein the light beam includes at least one predefined wavelength and at least one sending parameter associated with the wavelength;
acquiring at least one reflection beam diffracted at the observation position and/or transmission beam of the light beam having the predefined wavelength and transmitted through the hologram element at the observation position using at least one detector, wherein a detection parameter of the reflection beam and/or of the transmission beam is acquired at the predefined wavelength; and
comparing the sending parameter with the detection parameter to ascertain the diffraction characteristic of the hologram element at the observation position.
